(19) United States
(12) Patent Application Publication
(10) Pub. No.: US 2022/0312867 A1
(43) Pub. Date: Oct. 6, 2022

(54) Facemask with an Integrated Slit to Exhaust Exhaled Air

(71) Applicant: Edward Williams, Indianapolis, IN (US)

(72) Inventor: Edward Williams, Indianapolis, IN (US)

(21) Appl. No.: 17/708,060

(22) Filed: Mar. 30, 2022

Related U.S. Application Data
(60) Provisional application No. 63/167,908, filed on Mar. 30, 2021.

(51) Int. Cl. A41D 13/11

(52) U.S. Cl. CPC A41D 13/1107

(57) ABSTRACT

The present invention discloses a double-layered protective facemask. The protective facemask protects a user from germs, bacteria, and other pathogens. More specifically, the protective facemask comprises an outer layer, an inner layer, an adjustable right ear loop, and an adjustable left ear loop. The inner layer has a circular slit configured to be positioned near the mouth of a user when the facemask is worn and the outer layer has a circular vent at the bottom. A valve connecting member connects the circular slit and the circular vent and carries exhaled air from a user's mouth. A valve is detachably connected to the circular slit and is configured to be inserted into the mouth of the user to transport exhaled air to the valve connecting member. A plurality of apertures on the outer layer allow fresh air to be inhaled.

### CROSS-REFERENCE TO RELATED APPLICATION

The present application claims priority to, and the benefit of, U.S. Provisional Application No. 63/167,908, which was filed on Mar. 30, 2021 and is incorporated herein by reference in its entirety.

### FIELD OF THE INVENTION

The present invention relates generally to the field of protective face masks. More specifically, the present invention relates to a double-layered, antibacterial protective face mask configured to vent out the air exhaled by the user and prevent users from recycling their own breath. The improved face mask comprises a first layer covering the nose and mouth region, with a slit in the mouth region and a second layer which provides an increased layer of protection against the transmission of germs, bacteria and other harmful pathogens. The second layer comprises a small hole in which a valve-connecting member is connected to the slit of the first layer to vent out air which is exhaled through the mouth of users. The user can also use a valve in their mouth that connects to the slit, to properly vent out all the exhaled air. The improved face mask of the present invention offers a safer and more comfortable face mask, and improves peace of mind when travelling in public places. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, during a pandemic infectious diseases may spread across a large region including multiple continents or worldwide, and may affect a substantial number of individuals. There have been a number of pandemics in the past, such as smallpox, tuberculosis, Plague, Spanish Flu, etc. Current pandemics include HIV/AIDS and the Coronavirus (COVID-19). These pandemics are caused by an exponential spread of the virus, bacteria or pathogens which cause the infectious disease.

Generally, to prevent the spread of infectious diseases, people are often advised to follow social distancing guidelines, maintain personal hygiene, wear protective face masks and more. Wearing protective face masks in public areas prevents the spread of infectious diseases, as the mask acts as a barrier between the oral and nasal passages of the user and the outer environment, and also prevents the user from transmitting germs, viruses, bacteria and other harmful pathogens to others around them. Further, the use of face masks avoids contact between those who are infected with various viruses, bacteria or the like, and stops or slows down the rate and extent of disease transmission.

Typically, a face mask comprises a layer of protective fabric designed to cover the nose and mouth region of wearer, wherein the mask also includes ear loops to allow a user to easily keep the face mask in place. While using a standard face mask, the air exhaled out of a user's mouth gets trapped between the user's face and the fabric of the mask wherein a user then inhales back the air that was exhaled out of his or her mouth. This results in users not obtaining clean, fresh air to breathe, which may further cause breathing difficulties. Additionally, standard face masks known in the art fail to provide complete protection from the inhalation of germs, bacteria, viruses and other airborne pathogens that are incredibly dangerous and can lead to the spread of serious illnesses.

Therefore, there exists a long-felt need in the art for an improved face mask that provides better protection against the transmission of germs, viruses, bacteria and other harmful pathogens, and therefore prevents the spread of serious illnesses. There is also a long-felt need in the art for an improved face mask that can be comfortably worn while travelling in public places. Additionally, there is a long-felt need in the art for an improved face mask that prevents the user from inhaling the air exhaled out of their mouth. Moreover, there is a long-felt need in the art for an improved face mask that prevents suffocation and discomfort due to inhalation of air exhaled out of the mouth of a user. Further, there is a long-felt need in the art for an improved face mask that is efficient in preventing the spread of infectious diseases, and helps in the containment and mitigation of infectious diseases. Finally, there is a long-felt need in the art for an improved face mask that offers a safer, more comfortable and effective face mask and improves a wearer's peace of mind when traveling in public spaces.

The subject matter disclosed and claimed herein, in one embodiment thereof, comprises an improved face mask that is configured to protect a user from germs, bacteria, and pathogens. The mask comprises an outer layer, an inner layer, an adjustable right ear loop, an adjustable left ear loop, a circular slit in the inner layer configured to be positioned near the mouth of a user when the facemask is worn, a circular vent at the bottom of the outer layer and a valve connecting member connecting said circular slit and said circular vent together. The valve-connecting member is further configured to transport exhaled air from the mouth of the user to be expelled outside the mask. Further, a valve detachably connects to the circular slit and is configured to be inserted into the mouth of a user to transport exhaled air to said valve-connecting member. The mask is also comprised of a plurality of apertures on the outer layer allow fresh air to be inhaled. Therefore, the valve and the valve-connecting member easily exhaust the exhaled air and eliminate the recycling of the exhaled air.

In this manner, the novel improved face mask of the present invention accomplishes all of the forgoing objectives, and provides a relatively safe, easy and efficient solution to protecting a user from the transmission of germs, viruses, bacteria and other airborne pathogens in order to prevent the spread of infectious diseases. The improved face mask of the present invention is also user friendly, as it prevents the users from inhaling the air exhaled out of their mouths and prevents the user from breathing difficulty and discomfort due to the inhalation of exhaled air. Additionally, the double-layered mask provides additional protection against the transmission of harmful airborne pathogens and ensures a user's peace of mind in public places.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved face mask. The mask is configured to protect a user from germs, bacteria and pathogens causing infectious diseases such as COVID-19 or the like. The mask further comprises an outer layer, an inner layer, an adjustable right ear loop, an adjustable left ear loop, a circular slit in the inner layer configured to be positioned near the mouth of a user when the mask is worn, a circular vent at the bottom of the outer layer, and a valve-connecting member connecting said circular slit to said circular vent. The valve-connecting member is configured to carry exhaled air from the mouth of a user, and a valve detachably-connected to the circular slit is configured to be inserted into a mouth of the user to transport exhaled air to said connecting member. In addition, a plurality of apertures on the outer layer allow fresh air to be inhaled. As a result, the valve and the valve-connecting member easily exhaust the exhaled air and eliminate the recycling of the exhaled air.

In a further embodiment of the present invention, an improved face mask is disclosed. The mask comprises an inner layer configured to contact a user's nose and mouth, a valve configured to be inserted into a mouth of the user and attached to a slit of the inner layer and an outer layer disposed on the inner layer. Further, the outer layer comprises a vent at the bottom, where the slit of the inner layer and the vent on the outer layer are connected through a valve-connecting member to allow exhaled air to exhaust from the mouth through the valve and the valve-connecting member via the vent. The outer layer further comprises a plurality of apertures to allow fresh air to be inhaled easily and conveniently.

The mask may also be comprised of a double-layered anti-bacterial facemask that has an inner layer covering the nose and the mouth such that the inner layer has a slit near the mouth and is designed to exhaust exhaled air using a small valve inserted into a user's mouth. The mask may also have an outer layer including small holes or apertures to release the exhausted air of the user and a vent connected to said slit through a connecting member to carry the exhaled/exhausted air. The mask may also eliminate the fogging of glasses, sunglasses, goggles or other eyewear by expelling the user's exhaled air through a specified path via a valve and a valve connecting member. Thus, the facemask offers a safer, more comfortable and more effective face mask to improve peace of mind when traveling in public spaces.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a face mask of the present invention in accordance with the disclosed architecture;

FIG. 2 illustrates a side perspective view of a user wearing one potential embodiment of a face mask of the present invention in accordance with the disclosed architecture;

FIG. 3 illustrates a perspective view disclosing the inhale and exhale air movement of a user wearing one potential embodiment of a face mask of the present invention in accordance with the disclosed architecture; and

FIG. 4 illustrates a perspective view of different users wearing one potential embodiment of a face mask of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved face mask that provides improved protection against the transmission of germs, viruses, bacteria and other harmful pathogens, and therefore prevents the spread of serious illnesses. There is also a long-felt need in the art for an improved face mask that can be comfortably worn while travelling in public places. Additionally, there is a long-felt need in the art for an improved face mask that prevents the user from inhaling the air exhaled out of their mouth and prevents breathing difficulty and discomfort due to inhalation of expelled air. Further, there is a long-felt need in the art for an improved face mask that is efficient in the prevention of spreading infectious diseases and helps in containment and mitigation of such diseases. Finally, there is a long-felt need in the art for an improved face mask that offers a safer, more comfortable and more effective face mask, that improves a user's peace of mind when traveling in public spaces.

The present invention, in one exemplary embodiment, discloses an improved face mask. The mask comprises an inner layer configured to contact a user's nose and mouth, a valve configured to be inserted into a mouth of the user and attached to a slit of the inner layer, and an outer layer disposed on the inner layer. The outer layer is comprised of a vent at the bottom wherein the slit on the inner layer and the vent on the outer layer are connected through a valve connecting member. The valve connecting member allows exhaled air to be expelled from the mouth through the valve and the valve-connecting member via the vent. The outer layer also comprises a plurality of apertures to allow fresh air to be inhaled easily and conveniently.

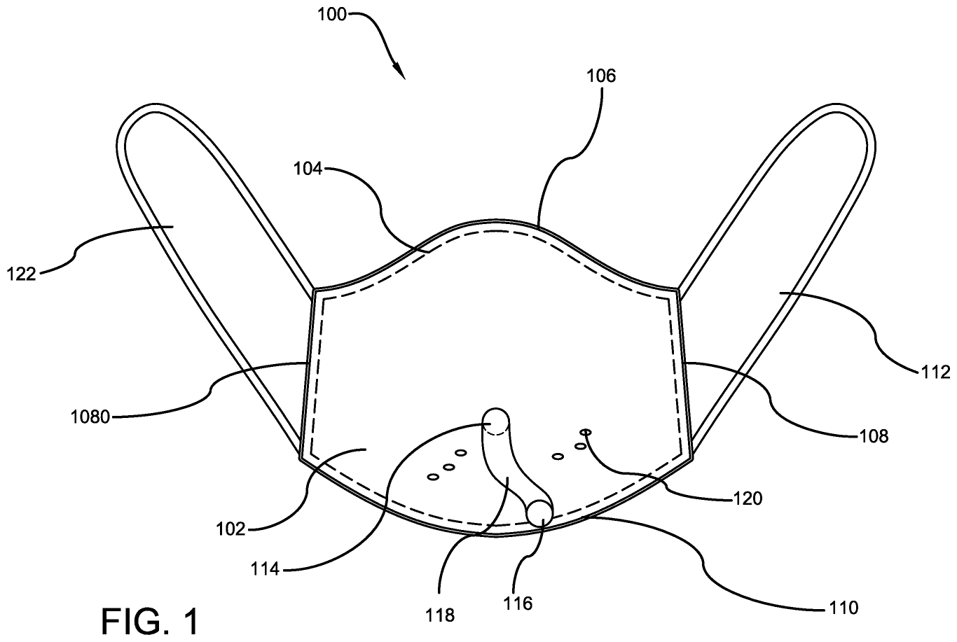

Referring initially to the drawings, FIG. 1 illustrates a perspective view of one potential embodiment of a face mask 100 of the present invention in accordance with the disclosed architecture. The mask 100 is configured to prevent germs, pathogens, bacteria, microbes, etc. from spreading outside the mask 100. The mask 100 is further comprised of two layers; an outer layer 102 and an inner layer 104. The inner layer 104 has a slit 114 positioned to be near the mouth of a user which is designed to expel the exhaled air of a user. The outer layer 102 further has a shape and contour substantially similar to the inner layer 104 and comprises a plurality of tiny apertures 120 (e.g. continuous openings) which allow fresh air to be inhaled easily and prevents the exhaled air from being recycled. In some embodiments, such as shown in a typical flat face mask, design pleats can be included to provide facial flexibility for improved fit and a greater surface area for a lower pressure drop per breath. In addition, different sized masks (i.e., S, M, L, XL) can be offered for an improved fit, comfort and feel.

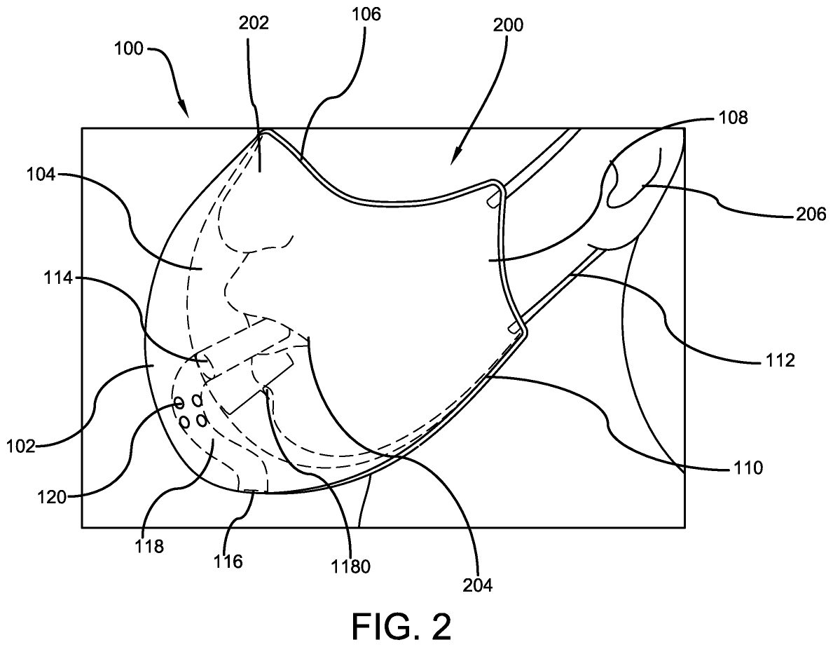

Further, a valve-connecting member 118 attached from the circular slit 114 of the inner layer 104 to a vent (or through hole/continuous opening) 116 at the bottom of the outer layer 102 is used for expelling the exhaled air. A valve 1180 (shown in FIG. 2) is integrated or detachably attached to the circular slit 114 and is configured to be inserted into a user's mouth to be used for expelling the exhaled air to the valve-connecting member 118 for easy removal. Additionally, the valve-connecting member 118 can be manufactured of fabric, flexible plastic or any other suitable material as is known in the art which allows the exhaled air to be expelled from the mask 100 easily. In another embodiment, the slit 114 and the vent 116 can be used as straw holes, thereby allowing a user to drink from a straw in public.

FIG. 2 illustrates a side perspective view of a user wearing one potential embodiment of a face mask 100 of the present invention in accordance with the disclosed architecture. As shown in FIG. 2, a user 200 wears the mask 100 to prevent the transmission of germs, pathogens, bacteria and microbes. The inner layer 104 of the mask 100 covers the nose 202 and lower face of the user 200. Further, the inner layer 104 comprises a slit 114 near the mouth 204 and is designed to expel the exhaled air of the user 200. The outer layer 102 of the facemask 100 has the same shape and contour of the inner layer 104 and comprises a plurality of tiny apertures 120 which allow a user 200 to inhale fresh air and prevents the exhaled breath from being recycled.

The mask 100 is also comprised of an adjustable left ear loop 112 and an adjustable right ear loop 122. The ear loops 112 and 122 are soft and elastic and are adjustable to fit all sizes. The facemask 100 has a top edge 106 designed to adhere to a user's face, side edges 108, 1080 and a chin cover 110 which provide complete facial protection.

The valve-connecting member 118 is designed to pass through the slit 114 of the inner layer 104 and is used to exhale air. The valve-connecting member 118 traverses through the slit 114 of the inner layer 104 to a hole or vent 116 at the bottom of the mask 100 in the outer layer 102. The exhaled air then travels through the valve-connecting member 118 from the mouth 204 to the hole 116, thereby allowing easy removal and providing additional safety to the user 200. The valve-connecting member 118 is preferably integrated into the facemask 100 between the inner layer 104 and the outer layer 102. A valve 1180 can be optionally placed into the mouth 204 of a user 200 to connect to the slit 114 to expel air from a user's mouth to the outside environment, through the circular vent/hole 116 at the bottom of the mask 100. Further, in conjunction with slit 114 of the inner layer 104 and the circular vent 116 at the bottom of the outer layer 102, the facemask 100 eliminates the fogging up of glasses, sunglasses, goggles or other eyewear.

Both the outer layer 102 and the inner layer 104 are sewn at the edges and are adhered to each other via any suitable fastening means as is known in the art. Further, the mask 100 covers the nasal and oral passages of the user 200 and has an adjustable left ear loop 112 for positioning on a left ear 206 and a similar adjustable right ear loop 122 (shown in FIG. 1) for positioning on a right ear. The ear loops 112 and 122 are soft and elastic and are adjustable to fit all sizes. The mask 100 has a top edge 106 designed to adhere to user's face, side edges 108 and a chin cover 110 to provide complete protection to the user 200. The outer layer 102 and the inner layer 104 can be manufactured of polyester, twill fabric, cloth or polypropylene fiber or cotton, etc., or any other suitable material known in the art. The mask 100 is breathable and stretchable such that it molds itself to the face of the user 200.

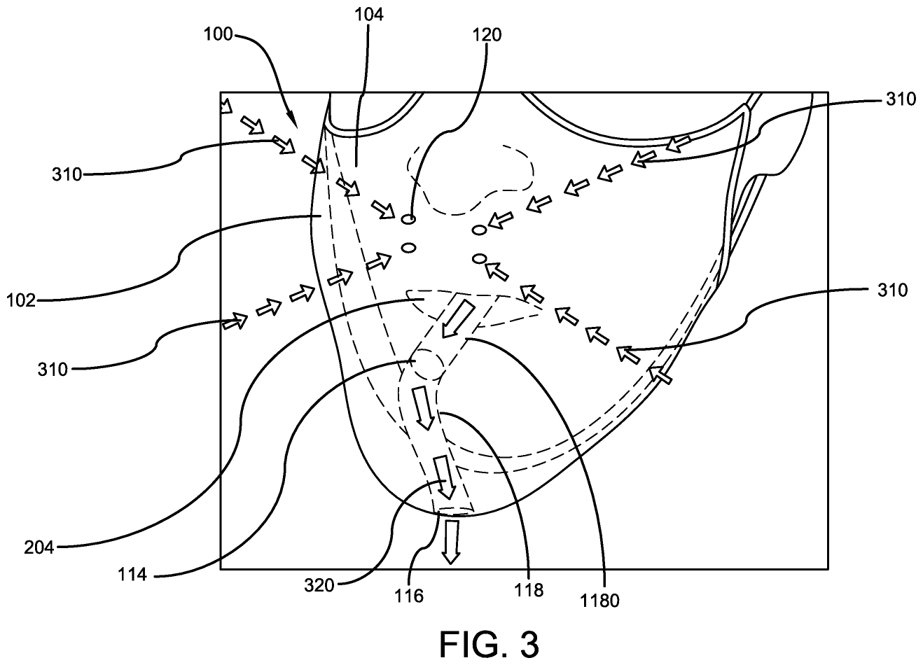

FIG. 3 illustrates a perspective view disclosing the inhale and exhale air movement of a user wearing one potential embodiment of a face mask 100 of the present invention in accordance with the disclosed architecture. Specifically, the exhaled air 320 from the mouth 204 of the user 200 traverses through the valve 1180 (from a user's mouth to slit 114 of inner layer 104) and valve-connecting member 118 (from slit 114 to vent 116 at the bottom of the facemask 100). The valve 1180 and the valve-connecting member 118 also prevent the recycling of exhaled air 320. A plurality of apertures 120 on the outer layer 102 allow fresh air 310 to be inhaled easily without recycling the exhaled air 320. Thus, the two layer structure of the facemask 100 maximizes a user's protection against the inhalation and spread of germs, viruses and bacteria.

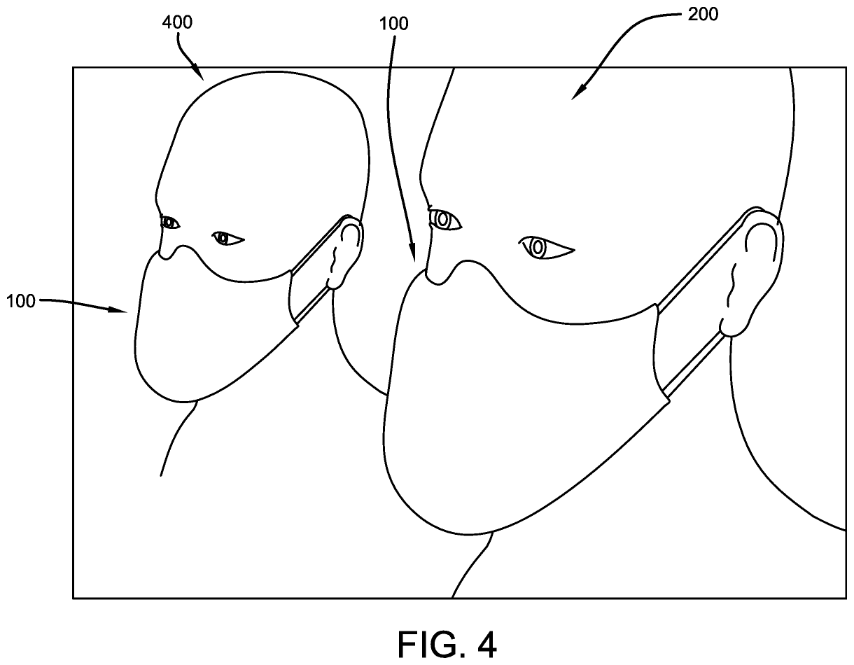

FIG. 4 illustrates a perspective view of different users wearing the protective facemask of the present invention in accordance with the disclosed architecture. As shown in FIG. 4, multiple users 200, 400 are disclosed wearing masks 100 of the present invention. The 100 of size M is worn by the user 400, to cover the nasal and oral passages of the user 400, and the medium-sized facemask 100 securely fits to the face of the user 400. Further, a mask 100 of size L is worn by the user 200, to cover the nasal and oral passages of the user 200 and the large-sized facemask 100 securely fits to the face of the user 200.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved face mask”, “face mask” and “mask”, are interchangeable and refer to the improved face mask 100 of the present invention.

Notwithstanding the forgoing, the improved face mask 100 of the present invention can be of any suitable size and configuration as is known in the art without affecting the overall concept of the invention, provided that it accomplishes the above-stated objectives. One of ordinary skill in the art will appreciate that the size, configuration and material of the improved face mask 100 as shown in FIGS. 1-4 are for illustrative purposes only, and that many other sizes and shapes of the improved face mask 100 are well within the scope of the present disclosure. Although the dimensions of the improved face mask 100 are important design parameters for user convenience, the improved face mask 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective facemask comprising:
an outer layer comprising a bottom and a vent, wherein the vent is positioned at the bottom of the outer layer;
an inner layer comprising a slit;
a valve connecting member secured between the vent in the outer layer and the slit of the inner layer for expelling exhaled air from a user;
a left ear loop; and
a right ear loop.

2. The protective facemask of claim 1, wherein the slit is positioned near a mouth of the user when the protective facemask is being worn by the user.

3. The protective facemask of claim 2, wherein the outer layer is comprised of a similar size and shape of the inner layer.

4. The protective facemask of claim 3, wherein the outer layer comprises a plurality of apertures which allow fresh air to be inhaled by the user.

5. The protective facemask of claim 4, wherein the slit of the inner layer is a circular-shaped slit.

6. The protective facemask of claim 5 further comprising a valve detachably attached to the slit of the inner layer.

7. The protective facemask of claim 6, wherein the valve is configured to be inserted into the mouth of the user for expelling the exhaled air to the valve connecting member.

8. The protective facemask of claim 7 further comprising a top edge, a pair of side edges, and a chin cover for fully covering a face of the user.

9. The protective facemask of claim 8, wherein a size of each of the left and the right ear loops are adjustable.

10. The protective facemask of claim 9, wherein the valve connecting member is manufactured of a fabric or a flexible plastic.

11. The protective facemask of claim 10, wherein the slit and the vent are sized and configured to receive a portion of a drinking straw.

12. A protective facemask comprising:
an adjustable left ear loop;
an adjustable right ear loop;
an outer layer having a bottom;
a vent positioned at the bottom of the outer layer;
an inner layer comprising a slit;
a valve connecting member secured between the vent in the outer layer and the slit of the inner layer for expelling an exhaled air from a user;
a valve detachably attached to the slit of the inner layer; and
a top edge, a pair of side edges and a chin cover.

13. The protective facemask of claim 12, wherein the valve is configured to be inserted into a mouth of the user for expelling the exhaled air to the valve connecting member.

14. The protective facemask of claim 12, wherein the valve connecting member is comprised of a fabric or a flexible plastic.

15. The protective facemask of claim 12, wherein the outer layer is comprised of a similar size and shape of the inner layer.

16. The protective facemask of claim 12, wherein the outer layer comprises a plurality of apertures which allow a fresh air to be inhaled by the user.

17. The protective facemask of claim 12, wherein the slit is circular in shape and is positioned near a mouth of the user.

18. A protective facemask comprising:
an adjustable left ear loop;
an adjustable right ear loop;
an outer layer comprising a vent at a bottom of the outer layer;
an inner layer comprising a slit; and
a valve connecting member secured between the vent in the outer layer and the slit of the inner layer, wherein the vent traverses through the slit.

19. The protective facemask of claim 18 further comprising a valve detachably attached to the slit of the inner layer and configured to be inserted into a user's mouth for expelling an exhaled air of a user to the valve connecting member, wherein the exhaled air traverses through the valve connecting member from the user's mouth to the vent and is then expelled outside the protective facemask.

20. The protective facemask of claim 19, wherein the exhaled air from the user's mouth traverses through the valve, the valve connecting member, and the vent of the outer layer, and is then expelled outside the protective facemask.
